(19) United States
(12) Patent Application Publication
(10) Pub. No.: US 2021/0106020 A1
(43) Pub. Date: Apr. 15, 2021

(54) FAT OR OIL COMPOSITION FOR COATING FROZEN DESSERT

(71) Applicant: FUJI OIL HOLDINGS INC., Izumisano-shi, Osaka (JP)

(72) Inventor: Akiyuki ISHIWATA, Tsukubamirai-shi, Ibaraki (JP)

(21) Appl. No.: 16/608,573

(22) PCT Filed: Apr. 3, 2018
(86) PCT No.: PCT/JP2018/014302

§ 371 Date: Oct. 25, 2019

(30) Foreign Application Priority Data
May 10, 2017 (JP) 2017-093743

(51) Int. Cl. A23D 7/00; A23D 7/01; A23G 1/30; A23G 1/36; A23G 9/48; A23L 29/10; A23P 20/10

(52) U.S. Cl. CPC A23D 7/003; A23D 7/011; A23G 1/305; A23V 2002/00; A23G 9/48; A23L 29/10; A23P 20/11; A23G 1/36

(57) ABSTRACT

An object of the present invention is to provide a soft fat and oil coating composition, the dripping time of which is short, and that enables efficient production of frozen confections. In the production of a frozen confection coated with a fat and oil composition that has a hardness of 200 to 1500 g as measured with a rheometer using a plunger having φ 5 mm at −18° C. at an intrusion rate of 5 cm/min, the time period during which the fat and oil composition drops can be shortened by forming the fat and oil composition so as to contain 0.1 to 3 wt % of fat and oil having a melting point of 50° C. or more and 0.05 to 3 wt % of an emulsifier having an HLB of 9 or less.

### TECHNICAL FIELD

The present invention relates to fat and oil coating compositions.

### BACKGROUND ART

Frozen confections whose surface is coated with a chocolate-like food product, such as ice cream bars, are known. Such frozen confections are often manufactured, for example, by dipping an ice cream bar in a bath of a chocolate-like food product to coat the surface of the ice cream bar with the chocolate-like food product.

For example, PTL 1 is a patent application for the use of an emulsifier for adjusting the physical properties of such a chocolate-like food product. PTL 1 teaches that chocolate-like coating food products are required to have properties such as excellent mouth-melt and short solidifying time after coating.

PTL 2 also discloses that the solidifying properties of coating chocolate are improved by adding a small amount of fully hydrogenated soybean oil or fully hydrogenated rapeseed oil.

PTL 3 is a patent application related to a technique of thickening fat and oil with an emulsifier. PTL 3 discloses that a specific polyglyceryl fatty acid ester can be a thickener for fat and oil.

### CITATION LIST

### Patent Literature

PTL 1: JPS60-241852

PTL 2: JPH06-133693

PTL 3: JP2007-106935

### SUMMARY OF INVENTION

### Technical Problem

An object of the present invention is to provide a soft fat and oil coating composition, the dripping time of which is short, and that enables efficient production of frozen confections.

### Solution to Problem

The present inventor conducted extensive research to achieve the object.

In the production of a frozen confection coated with a chocolate-like food product using a production method in which an ice cream bar is dipped in a bath of the chocolate-like food product for coating the bar, after the ice cream bar is pulled out of the bath of the chocolate-like food product, the chocolate-like food product desirably stops “dripping” quickly.

PTL 1 discloses that the coating weight of coating chocolate can be decreased by adding polyglyceryl condensed ricinoleate. However, decreasing the coating weight is irrelevant to achievement of the object; rather, a suitable amount of coating is necessary to accentuate the presence of the chocolate-like food product. Thus, PTL 1 is not helpful.

“Improvement of solidifying properties,” which is a purpose of PTL 2, differs from “shortening dripping time,” which is an object of the present invention. Thus, PTL 2 is not helpful. The inventor conducted further research, and found that the time period during which a fat and oil composition drips in the production of a frozen confection can be shortened by adding fat and oil that has a melting point beyond a certain temperature to a fat and oil coating composition that is relatively soft at or below freezing point, in an amount such that the fat and oil does not affect the feel of mouth-melt; and further adding a specific emulsifier. The inventor then completed the present invention.

Specifically, the present invention relates to the following:

(1) A fat and oil composition for coating frozen confections,

the composition comprising
0.1 to 3 wt % of fat and oil having a melting point of 50° C. or more, and
0.05 to 3 wt % of an emulsifier having an HLB of 9 or less,

the composition having a hardness of 200 to 1500 g as measured with a rheometer using a plunger having φ 5 mm (a diameter of 5 mm) at −18° C. at an intrusion rate of 5 cm/min;

(2) The fat and oil composition for coating frozen confections according to (1), wherein the emulsifier having an HLB of 9 or less is at least one member selected from the group consisting of sugar esters and sorbitan fatty acid esters;
(3) The fat and oil composition for coating frozen confections according to (1), wherein the fat and oil having a melting point of 50° C. or more is a fully hydrogenated high-erucic-acid rapeseed oil;
(4) The fat and oil composition for coating frozen confections according to (2), wherein the fat and oil having a melting point of 50° C. or more is a fully hydrogenated high-erucic-acid rapeseed oil;
(5) A method for producing a frozen confection coated with a fat and oil composition, the method using the fat and oil composition for coating frozen confections according to (1);
(6) A method for producing a frozen confection coated with a fat and oil composition, the method using the fat and oil composition for coating frozen confections according to (2);
(7) A method for producing a frozen confection coated with a fat and oil composition, the method using the fat and oil composition for coating frozen confections according to (3);
(8) A method for producing a frozen confection coated with a fat and oil composition, the method using the fat and oil composition for coating frozen confections according to (4);
(9) A method for shortening the time period during which a fat and oil composition drops in the production of a frozen confection,

the method comprising forming the fat and oil composition so as to contain 0.1 to 3 wt % of fat and oil having a melting point of 50° C. or more and 0.05 to 3 wt % of an emulsifier having an HLB of 9 or less in the production of a frozen confection coated with the fat and oil composition,

wherein the fat and oil composition has a hardness of 200 to 1500 g as measured with a rheometer using a plunger having φ 5 mm (a diameter of 5 mm) at −18° C. at an intrusion rate of 5 cm/min;

(10) The method for shortening the time period during which a fat and oil composition drops in the production of a frozen confection according to (9), wherein the emulsifier having an HLB of 9 or less is at least one member selected from the group consisting of sugar esters and sorbitan fatty acid esters;
(11) The method for shortening the time period during which a fat and oil composition drops in the production of a frozen confection according to (9), wherein the fat and oil having a melting point of 50° C. or more is a fully hydrogenated high-erucic-acid rapeseed oil;
(12) The method for shortening the time period during which a fat and oil composition drops in the production of a frozen confection according to (10), wherein the fat and oil having a melting point of 50° C. or more is a fully hydrogenated high-erucic-acid rapeseed oil.

In other words, the present invention relates to the following:

(21) A fat and oil composition for coating frozen confections,

the composition comprising
0.1 to 3 wt % of fat and oil having a melting point of 50° C. or more, and
0.05 to 3 wt % of an emulsifier having an HLB of 9 or less,

the composition having a hardness of 200 to 1500 g as measured with a rheometer using a plunger having φ 5 mm (a diameter of 5 mm) at −18° C. at an intrusion rate of 5 cm/min;

(22) The fat and oil composition for coating frozen confections according to (21), wherein the emulsifier is at least one member selected from the group consisting of sugar esters and sorbitan fatty acid esters;
(23) A method for producing a frozen confection coated with a fat and oil composition, the method using the fat and oil composition for coating frozen confections according to (21) or (22);
(24) A method for shortening the time period during which a fat and oil composition drops in the production of a frozen confection,

the method comprising forming the fat and oil composition so as to contain 0.1 to 3 wt % of fat and oil having a melting point of 50° C. or more and 0.05 to 3 wt % of an emulsifier having an HLB of 9 or less in the production of a frozen confection coated with the fat and oil composition,

wherein the fat and oil composition has a hardness of 200 to 1500 g as measured with a rheometer using a plunger having φ 5 mm (a diameter of 5 mm) at −18° C. at an intrusion rate of 5 cm/min

### Advantageous Effects of Invention

The present invention provides a soft fat and oil coating composition, the dripping time of which is short, and that enables efficient production of frozen confections.

### DESCRIPTION OF EMBODIMENTS

The term “frozen confection” as used in the present invention is a general term that refers to food products that are eaten in a chilled state. Specifically, the frozen confection includes ice cream and ice pops. As used in the present invention, ice cream widely includes ice-milk and lacto-ice.

The fat and oil composition as used in the present invention refers to a composition made from fat and oil (a starting material), and typically a chocolate-like food product. The fat and oil coating composition as used in the present invention refers to a fat and oil composition that is used for the purpose of coating the surface of a food product.

A feature of the physical properties of the fat and oil composition for coating frozen confections according to the present invention is its hardness of 200 to 1500 g as measured with a rheometer using a plunger having φ 5 mm (a diameter of 5 mm) at −18° C. at an intrusion rate of 5 cm/min. The hardness is more preferably 300 to 700 g, and still more preferably 350 to 650 g. A frozen confection produced using a fat and oil coating composition that has a suitable hardness is preferable, because the flavor of the fat and oil composition is strongly perceived when the confection is eaten.

Typical fat and oil compositions for coating frozen confections are harder at −18° C. in their physical properties. In the present invention, a fat and oil composition having the physical properties described above is used so that the flavor is more strongly perceived. To make the physical properties of a fat and oil composition as soft as described above, the content of fat and oil having a low melting point, such as liquid oils, can be increased to suitably adjust the physical properties.

However, due to the softer-than-usual properties, such a fat and oil composition “drops” for a long time when an ice cream bar is produced, often affecting the production efficiency of the frozen confection. Thus, the technique of the present invention is necessary.

When a frozen confection coated with a fat and oil composition (in particular, an ice cream bar) is prepared, the coating operation is typically performed by solidifying ice cream on a bar, dipping the ice cream bar in a fat and oil coating composition in a fluidized state, and pulling the ice cream bar out of the composition. However, when a soft fat and oil coating composition as in the present invention is used, the fat and oil composition continues to drop for a relatively long time after the ice cream is pulled out of the composition. Thus, the ice cream must be held for a predetermined period of time until the composition stops dripping, which often makes the production of frozen confections less efficient.

The “melting point” as used in the present invention refers to a rising melting point. An outline of the measurement method is as follows. The inside of a capillary tube is filled with fat and oil; and the fat and oil is solidified, followed by immersing the solidified fat and oil in water. While the temperature of water is increased, the temperature at which the sample starts rising up inside the capillary tube is measured. The details are described in the JOCS Standard Methods for the Analysis of Fats, Oils and Related Materials (1) (1996 edition).

The fat and oil coating composition in the present invention must contain 0.1 to 3 wt % of fat and oil having a melting point of 50° C. or more. The melting point is preferably 55° C. or more, and more preferably 58° C. or more. Examples of such fat and oil include hydrogenated oils of a range of fats and oils. Specifically, such fat and oil is hydrogenated oils of soybean oil, rapeseed oil, palm oil, rice oil, or corn oil; preferably a fully hydrogenated high-erucic-acid rapeseed oil, a fully hydrogenated soybean oil, and a fully hydrogenated palm oil; and most preferably a fully hydrogenated high-erucic-acid rapeseed oil.

The content of the fat and oil having a melting point of 50° C. or more is more preferably 0.2 to 2.5 wt %, and still more preferably 0.3 to 2 wt %. A suitable content of the fat and oil provides the fat and oil coating composition with desired physical properties.

Due to the specific fat and oil contained, the fat and oil coating composition according to the present invention can shorten dripping time after the coating step in the production of a frozen confection, thus enabling efficient production of a frozen confection.

In the present invention, 0.05 to 3 wt % of an emulsifier having an HLB of 9 or less is used. The type of the emulsifier is preferably at least one member selected from sugar esters and sorbitan fatty acid esters. The emulsifier is more preferably a sugar ester. The content of the emulsifier is preferably 0.1 to 2.5 wt %, and more preferably 0.15 to 2 wt %. The use of a suitable type of an emulsifier in a suitable amount provides the fat and oil coating composition with suitable physical properties.

The HLB of the emulsifier is preferably 4 to 8, and more preferably 5 to 8. The use of an emulsifier with a suitable HLB provides the fat and oil coating composition with suitable physical properties.

The present invention also relates to a method for producing a frozen confection coated with a fat and oil composition, a feature of which is the use of the fat and oil coating composition described above. The use of the fat and oil composition can shorten the time period during which the fat and oil composition drops after ice cream is pulled out of the composition, thus enabling the efficient production of a frozen confection.

The present invention also relates to a method for shortening the time period during which a fat and oil composition drops in the production of a frozen confection coated with the fat and oil composition that has a hardness of 200 to 1500 g as measured with a rheometer using a plunger having φ 5 mm (a diameter of 5 mm) at −18° C. at an intrusion rate of 5 cm/min. More specifically, the time period during which a fat and oil composition drops in the production of a frozen confection using the fat and oil composition can be decreased by forming the fat and oil composition so as to contain 0.1 to 3 wt % of fat and oil having a melting point of 50° C. or more and 0.05 to 3 wt % of an emulsifier having an HLB of 9 or less.

The fat and oil for use in the fat and oil composition for coating frozen confections according to the present invention may be those based on a liquid oil, such as soybean oil, rapeseed oil, rice oil, sunflower oil, or cottonseed oil. However, other fat and oil may also be suitably used, as long as the resulting fat and oil coating composition can have the physical properties of a predetermined value.

In the present invention, not only the predetermined starting materials described above, but also other typical starting materials for use in fat and oil coating compositions, may be used. Specifically, flavor materials, such as cocoa, sugar, and flavoring, may be used, as long as the effect of the present invention is not impaired.

The following describes Examples.

### EXAMPLES

### Study 1

In accordance with the formulations shown in Table 1, chocolate-like coating food products were prepared. The preparation method followed is described in the section “Method for Preparing Chocolate-Like Coating Food Product” below.

The viscosity of the obtained chocolate-like coating food products was evaluated. The evaluation was performed in accordance with the “Viscosity Evaluation Method.” Table 2 shows the results.

An adhesion test (coating test) was performed on frozen confections using the chocolate-like coating food products. The test was performed in accordance with the “Adhesion Test Method.” Table 2 shows the results.

TABLE 1
Formulations

| | Compa- | Compa- | Compa- | Compa- | Compa- | Compa- | Compa- | Compa- | Compa- | Compa- |
|---|---|---|---|---|---|---|---|---|---|---|
| | rative | rative | rative | rative | rative | rative | rative | rative | rative | rative |
| | Exam- | Exam- | Exam- | Exam- | Exam- | Exam- | Exam- | Exam- | Exam- | Exam- |
| | ple 1 | ple 2 | ple 3 | ple 4 | ple 5 | ple 6 | ple 7 | ple 8 | ple 9 | ple 10 |
| Cocoa Powder | 9.50 | 9.50 | 9.50 | 9.50 | 9.50 | 9.50 | 9.50 | 9.50 | 9.50 | 9.50 |
| Powdered Sugar | 30.00 | 30.00 | 30.00 | 30.00 | 30.00 | 30.00 | 30.00 | 30.00 | 30.00 | 30.00 |
| Non-Fat Dry | 5.00 | 5.00 | 5.00 | 5.00 | 5.00 | 5.00 | 5.00 | 5.00 | 5.00 | 5.00 |
| Milk Powder | | | | | | | | | | |
| Soybean Oil | 55.00 | 54.50 | 54.00 | 54.75 | 54.50 | 54.00 | 54.75 | 54.00 | 54.85 | 54.65 |
| Medium-Chain | — | — | — | — | — | — | — | — | — | — |
| Triglycerides | | | | | | | | | | |
| Fully Hydrogenated | — | 0.50 | 1.00 | — | — | — | — | — | — | — |
| High Erucic | | | | | | | | | | |
| Acid Rapeseed Oil | | | | | | | | | | |
| (Melting Point: | | | | | | | | | | |
| 61° C.) | | | | | | | | | | |
| Fully Hydrogenated | — | — | — | — | — | — | — | — | — | — |
| Palm Oil (Melting | | | | | | | | | | |
| Point: 58° C.) | | | | | | | | | | |
| Hydrogenated | — | — | — | — | — | — | — | — | — | — |
| Soybean Oil | | | | | | | | | | |
| (Melting Point: | | | | | | | | | | |
| 52° C.) | | | | | | | | | | |
| Lecithin | 0.50 | 0.50 | 0.50 | 0.50 | 0.50 | 0.50 | 0.50 | 0.50 | 0.50 | 0.50 |
| Emulsifier 1 | — | — | — | — | — | — | 0.25 | 1.00 | — | — |
| Emulsifier 2 | — | — | — | 0.25 | 0.50 | 1.00 | — | — | — | — |
| Emulsifier 3 | — | — | — | — | — | — | — | — | 0.15 | 0.35 |
| Emulsifier 4 | — | — | — | — | — | — | — | — | | |
| | 100.00 | 100.00 | 100.00 | 100.00 | 100.00 | 100.00 | 100.00 | 100.00 | 100.00 | 100.00 |
| | Compa- | Compa- | Compa- | Compa- | Compa- | Compa- | Compa- | Compa- | Compa- | Compa- |
| | rative | rative | rative | rative | rative | rative | rative | rative | rative | rative |
| | Exam- | Exam- | Exam- | Exam- | Exam- | Exam- | Exam- | Exam- | Exam- | Exam- |
| | ple 11 | ple 12 | ple 13 | ple 14 | ple 15 | ple 16 | ple 17 | ple 18 | ple 19 | ple 20 |
| Cocoa Powder | 9.5 | 9.5 | 9.5 | 9.5 | 9.5 | 9.5 | 9.5 | 9.5 | 9.5 | 9.5 |
| Powdered Sugar | 30.0 | 30.0 | 30.0 | 30.0 | 30.0 | 30.0 | 30.0 | 30.0 | 30.0 | 30.0 |
| Non-Fat Dry | 5.0 | 5.0 | 5.0 | 5.0 | 5.0 | 5.0 | 5.0 | 5.0 | 5.0 | 5.0 |
| Milk Powder | | | | | | | | | | |
| Soybean Oil | 54.5 | 54.9 | 54.7 | 54.5 | 54.5 | 54.0 | 54.5 | 54.0 | — | — |
| Medium-Chain | — | — | — | — | — | — | — | — | 55.0 | 54.5 |
| Triglycerides | | | | | | | | | | |
| Fully Hydrogenated | — | — | — | — | — | — | — | — | — | 0.5 |
| High Erucic | | | | | | | | | | |
| Acid Rapeseed Oil | | | | | | | | | | |
| (Melting Point: | | | | | | | | | | |
| 61° C.) | | | | | | | | | | |
| Fully Hydrogenated | — | — | — | — | 0.5 | 1.0 | — | — | — | — |
| Palm Oil (Melting | | | | | | | | | | |
| Point: 58° C.) | | | | | | | | | | |
| Hydrogenated | — | — | — | — | — | — | 0.5 | 1.0 | — | — |
| Soybean Oil | | | | | | | | | | |
| (Melting Point: | | | | | | | | | | |
| 52° C.) | | | | | | | | | | |
| Lecithin | 0.5 | 0.5 | 0.5 | 0.5 | 0.5 | 0.5 | 0.5 | 0.5 | 0.5 | 0.5 |
| Emulsifier 1 | — | — | — | — | — | — | — | — | — | — |
| Emulsifier 2 | — | — | — | — | — | — | — | — | — | — |
| Emulsifier 3 | 0.5 | | | | — | — | — | — | — | — |
| Emulsifier 4 | | 0.2 | 0.4 | 0.5 | — | — | — | — | — | — |
| | 100.0 | 100.0 | 100.0 | 100.0 | 100.0 | 100.0 | 100.0 | 100.0 | 100.0 | 100.0 |
| | Compa- | Compa- | Compa- | Compa- | | | | | | |
| | rative | rative | rative | rative | | | | | | |
| | Exam- | Exam- | Exam- | Exam- | Exam- | Exam- | Exam- | Exam- | Exam- | Exam- |
| | ple 21 | ple 22 | ple 23 | ple 24 | ple 1 | ple 2 | ple 3 | ple 4 | ple 5 | ple 6 |
| Cocoa Powder | 9.5 | 9.5 | 9.5 | 9.5 | 9.5 | 9.5 | 9.5 | 9.5 | 9.5 | 9.5 |
| Powdered Sugar | 30.0 | 30.0 | 30.0 | 30.0 | 30.0 | 30.0 | 30.0 | 30.0 | 30.0 | 30.0 |
| Non-Fat Dry | 5.0 | 5.0 | 5.0 | 5.0 | 5.0 | 5.0 | 5.0 | 5.0 | 5.0 | 5.0 |
| Milk Powder | | | | | | | | | | |
| Soybean Oil | — | — | — | — | 54.5 | 54.3 | 53.8 | 54.0 | 53.5 | 53.5 |
| Medium-Chain | 54.0 | 54.8 | 54.5 | 54.0 | — | — | — | — | — | — |
| Triglycerides | | | | | | | | | | |
| Fully Hydrogenated | 1.0 | — | — | — | — | 0.5 | 1.0 | 0.5 | 1.0 | 0.5 |
| High Erucic | | | | | | | | | | |
| Acid Rapeseed Oil | | | | | | | | | | |
| (Melting Point: | | | | | | | | | | |
| 61° C.) | | | | | | | | | | |
| Fully Hydrogenated | — | — | — | — | — | — | — | — | — | — |
| Palm Oil (Melting | | | | | | | | | | |
| Point: 58° C.) | | | | | | | | | | |
| Hydrogenated | — | — | — | — | — | — | — | — | — | — |
| Soybean Oil | | | | | | | | | | |
| (Melting Point: | | | | | | | | | | |
| 52° C.) | | | | | | | | | | |
| Lecithin | 0.5 | 0.5 | 0.5 | 0.5 | 0.5 | 0.5 | 0.5 | 0.5 | 0.5 | 0.5 |
| Emulsifier 1 | — | — | — | — | 0.5 | | | | | |
| Emulsifier 2 | — | 0.3 | 0.5 | 1.0 | | 0.3 | 0.3 | 0.5 | 0.5 | 1.0 |
| Emulsifier 3 | — | — | — | — | — | — | — | — | — | — |
| Emulsifier 4 | — | — | — | — | — | — | — | — | — | — |
| | 100.0 | 100.0 | 100.0 | 100.0 | 100.0 | 100.0 | 100.0 | 100.0 | 100.0 | 100.0 |
| | Exam- | Exam- | Exam- | Exam- | Exam- | Exam- | Exam- | Exam- | Exam- | Exam- |
| | ple 7 | ple 8 | ple 9 | ple 10 | ple 11 | ple 12 | ple 13 | ple 14 | ple 15 | ple 16 |
| Cocoa Powder | 9.5 | 9.5 | 9.5 | 9.5 | 9.5 | 9.5 | 9.5 | 9.5 | 9.5 | 9.5 |
| Powdered Sugar | 30.0 | 30.0 | 30.0 | 30.0 | 30.0 | 30.0 | 30.0 | 30.0 | 30.0 | 30.0 |
| Non-Fat Dry | 5.0 | 5.0 | 5.0 | 5.0 | 5.0 | 5.0 | 5.0 | 5.0 | 5.0 | 5.0 |
| Milk Powder | | | | | | | | | | |
| Soybean Oil | 53.0 | 54.3 | 53.8 | 54.0 | 53.5 | 53.5 | 53.0 | 54.4 | 53.9 | 54.2 |
| Medium-Chain | — | — | — | — | — | — | — | — | — | — |
| Triglycerides | | | | | | | | | | |
| Fully Hydrogenated | 1.0 | 0.5 | 1.0 | 0.5 | 1.0 | 0.5 | 1.0 | 0.5 | 1.0 | 0.5 |
| High Erucic | | | | | | | | | | |
| Acid Rapeseed Oil | | | | | | | | | | |
| (Melting Point: | | | | | | | | | | |
| 61° C.) | | | | | | | | | | |
| Fully Hydrogenated | — | — | — | — | — | — | — | — | — | — |
| Palm Oil (Melting | | | | | | | | | | |
| Point: 58° C.) | | | | | | | | | | |
| Hydrogenated | — | — | — | — | — | — | — | — | — | — |
| Soybean Oil | | | | | | | | | | |
| (Melting Point: | | | | | | | | | | |
| 52° C.) | | | | | | | | | | |
| Lecithin | 0.5 | 0.5 | 0.5 | 0.5 | 0.5 | 0.5 | 0.5 | 0.5 | 0.5 | 0.5 |
| Emulsifier 1 | | 0.3 | 0.3 | 0.5 | 0.5 | 1.0 | 1.0 | — | — | — |
| Emulsifier 2 | 1.0 | — | — | — | — | — | — | — | — | — |
| Emulsifier 3 | — | — | — | — | — | — | — | 0.2 | 0.2 | 0.4 |
| Emulsifier 4 | — | — | — | — | — | — | — | | | |
| | 100.0 | 100.0 | 100.0 | 100.0 | 100.0 | 100.0 | 100.0 | 100.0 | 100.0 | 100.0 |
| | Exam- | Exam- | Exam- | Exam- | Exam- | Exam- | Exam- | Exam- | Exam- | Exam- |
| | ple 17 | ple 18 | ple 19 | ple 20 | ple 21 | ple 22 | ple 23 | ple 24 | ple 25 | ple 26 |
| Cocoa Powder | 9.5 | 9.5 | 9.5 | 9.5 | 9.5 | 9.5 | 9.5 | 9.5 | 9.5 | 9.5 |
| Powdered Sugar | 30.0 | 30.0 | 30.0 | 30.0 | 30.0 | 30.0 | 30.0 | 30.0 | 30.0 | 30.0 |
| Non-Fat Dry | 5.0 | 5.0 | 5.0 | 5.0 | 5.0 | 5.0 | 5.0 | 5.0 | 5.0 | 5.0 |
| Milk Powder | | | | | | | | | | |
| Soybean Oil | 53.7 | 54.0 | 53.5 | 54.4 | 53.9 | 54.2 | 53.7 | 54.0 | 53.5 | 54.3 |
| Medium-Chain | — | — | — | — | — | — | — | — | — | — |
| Triglycerides | | | | | | | | | | |
| Fully Hydrogenated | 1.0 | 0.5 | 1.0 | 0.5 | 1.0 | 0.5 | 1.0 | 0.5 | 1.0 | — |
| High Erucic | | | | | | | | | | |
| Acid Rapeseed Oil | | | | | | | | | | |
| (Melting Point: | | | | | | | | | | |
| 61° C.) | | | | | | | | | | |
| Fully Hydrogenated | — | — | — | — | — | — | — | — | — | 0.5 |
| Palm Oil (Melting | | | | | | | | | | |
| Point: 58° C.) | | | | | | | | | | |
| Hydrogenated | — | — | — | — | — | — | — | — | — | — |
| Soybean Oil | | | | | | | | | | |
| (Melting Point: | | | | | | | | | | |
| 52° C.) | | | | | | | | | | |
| Lecithin | 0.5 | 0.5 | 0.5 | 0.5 | 0.5 | 0.5 | 0.5 | 0.5 | 0.5 | 0.5 |
| Emulsifier 1 | — | — | — | — | — | — | — | — | — | — |
| Emulsifier 2 | — | — | — | — | — | — | — | — | — | 0.3 |
| Emulsifier 3 | 0.4 | 0.5 | 0.5 | — | — | — | — | — | — | — |
| Emulsifier 4 | | | | 0.2 | 0.2 | 0.4 | 0.4 | 0.5 | 0.5 | — |
| | 100.0 | 100.0 | 100.0 | 100.0 | 100.0 | 100.0 | 100.0 | 100.0 | 100.0 | 100.0 |
| | Exam- | Exam- | Exam- | Exam- | Exam- | Exam- | Exam- | Exam- | Exam- | Exam- |
| | ple 27 | ple 28 | ple 29 | ple 30 | ple 31 | ple 32 | ple 33 | ple 34 | ple 35 | ple 36 |
| Cocoa Powder | 9.5 | 9.5 | 9.5 | 9.5 | 9.5 | 9.5 | 9.5 | 9.5 | 9.5 | 9.5 |
| Powdered Sugar | 30.0 | 30.0 | 30.0 | 30.0 | 30.0 | 30.0 | 30.0 | 30.0 | 30.0 | 30.0 |
| Non-Fat Dry | 5.0 | 5.0 | 5.0 | 5.0 | 5.0 | 5.0 | 5.0 | 5.0 | 5.0 | 5.0 |
| Milk Powder | | | | | | | | | | |
| Soybean Oil | 53.8 | 54.0 | 53.5 | 53.5 | 53.0 | 54.3 | 53.8 | 54.0 | 53.5 | 53.5 |
| Medium-Chain | — | — | — | — | — | — | — | — | — | — |
| Triglycerides | | | | | | | | | | |
| Fully Hydrogenated | — | — | — | — | — | — | — | — | — | — |
| High Erucic | | | | | | | | | | |
| Acid Rapeseed Oil | | | | | | | | | | |
| (Melting Point: | | | | | | | | | | |
| 61° C.) | | | | | | | | | | |
| Fully Hydrogenated | 1.0 | 0.5 | 1.0 | 0.5 | 1.0 | — | — | — | — | — |
| Palm Oil (Melting | | | | | | | | | | |
| Point: 58° C.) | | | | | | | | | | |
| Hydrogenated | — | — | — | — | — | 0.5 | 1.0 | 0.5 | 1.0 | 0.5 |
| Soybean Oil | | | | | | | | | | |
| (Melting Point: | | | | | | | | | | |
| 52° C.) | | | | | | | | | | |
| Lecithin | 0.5 | 0.5 | 0.5 | 0.5 | 0.5 | 0.5 | 0.5 | 0.5 | 0.5 | 0.5 |
| Emulsifier 1 | — | — | — | — | — | — | — | — | — | — |
| Emulsifier 2 | 0.3 | 0.5 | 0.5 | 1.0 | 1.0 | 0.3 | 0.3 | 0.5 | 0.5 | 1.0 |
| Emulsifier 3 | — | — | — | — | — | — | — | — | — | — |
| Emulsifier 4 | — | — | — | — | — | — | — | — | — | — |
| | 100.0 | 100.0 | 100.0 | 100.0 | 100.0 | 100.0 | 100.0 | 100.0 | 100.0 | 100.0 |

| | | | | | | Exam- | Exam- |
|---|---|---|---|---|---|---|---|
| | Example 37 | Example 38 | Example 39 | Example 40 | Example 41 | ple 42 | ple 43 |
| Cocoa Powder | 9.5 | 9.5 | 9.5 | 9.5 | 9.5 | 9.5 | 9.5 |
| Powdered Sugar | 30.0 | 30.0 | 30.0 | 30.0 | 30.0 | 30.0 | 30.0 |
| Non-Fat Dry | 5.0 | 5.0 | 5.0 | 5.0 | 5.0 | 5.0 | 5.0 |
| Milk Powder | | | | | | | |
| Soybean Oil | 53.0 | | | | | | |
| Medium-Chain | — | 54.3 | 53.8 | 54.0 | 53.5 | 53.5 | 53.0 |
| Triglycerides | | | | | | | |
| Fully Hydrogenated | — | 0.5 | 1.0 | 0.5 | 1.0 | 0.5 | 1.0 |
| High Erucic | | | | | | | |
| Acid Rapeseed Oil | | | | | | | |
| (Melting Point: | | | | | | | |
| 61° C.) | | | | | | | |
| Fully Hydrogenated | — | — | — | — | — | — | — |
| Palm Oil (Melting | | | | | | | |
| Point: 58° C.) | | | | | | | |
| Hydrogenated | 1.0 | — | — | — | — | — | — |
| Soybean Oil | | | | | | | |
| (Melting Point: | | | | | | | |
| 52° C.) | | | | | | | |
| Lecithin | 0.5 | 0.5 | 0.5 | 0.5 | 0.5 | 0.5 | 0.5 |
| Emulsifier 1 | — | — | — | — | — | — | — |
| Emulsifier 2 | 1.0 | 0.3 | 0.3 | 0.5 | 0.5 | 1.0 | 1.0 |
| Emulsifier 3 | — | — | — | — | — | — | — |
| Emulsifier 4 | — | — | — | — | — | — | — |
| | 100.0 | 100.0 | 100.0 | 100.0 | 100.0 | 100.0 | 100.0 |

(unit: wt %)

For emulsifier 1, Sugar Ester S-070 (Mitsubishi-Chemical Foods Corporation) was used. This emulsifier is sucrose stearate with an HLB of 1 or less, and a combined fatty acid purity of about 70%.
For emulsifier 2, Sugar Ester S-770 (Mitsubishi-Chemical Foods Corporation) was used. This emulsifier is sucrose stearate with an HLB of about 7, and a combined fatty acid purity of about 70%.
For emulsifier 3, Poem S60V (Riken Vitamin Co., Ltd.) was used. This emulsifier is sorbitan monostearate with an HLB of 5.1.
For emulsifier 4, Emasol S30V (Kao Corporation) was used. This emulsifier is sorbitan tristearate with an HLB of 2.1.
For medium-chain triglycerides, MCT-64 (Fuji Oil Co., Ltd.) was used.
The cocoa powder used had a fat content of 11 wt %.

### Method for Preparing Chocolate-Like Coating Food Product

1. In accordance with the formulations shown in Table 1, the full amount of cocoa, non-fat dry milk powder, and sugar; and part of a melting mixture of the fat and oil starting materials, were mixed with a hot-water-jacketed mixer, and formed into a material that had a suitable hardness at 50° C.
2. The material was subjected to particle-size reduction treatment with a roll refiner, and adjusted to have a particle size of about 17 to 23 μm as measured with a micrometer.
3. While being kneaded with a conche, the material was mixed with the remaining melting mixture of the fat and oil starting materials, lecithin, and an emulsifier, thereby preparing an oily food product. Note that the emulsifier was mixed with the remaining melting mixture of the fat and oil starting materials with heating to melt the emulsifier, and added to the material during conching.

### Hardness Evaluation Method

1. A chocolate-like coating food product was placed in φ 50 mm (a 50 mm-diameter) container to give a thickness of 2 cm.
2. The chocolate-like food product was placed in deep-freezing equipment for 3 hours to solidify the chocolate-like food product.
3. The chocolate-like food product was transferred to a freezer at −18° C., and left for 24 hours.
4. The hardness of the chocolate-like food product was measured with a rheometer using a plunger having φ 5 mm (a diameter of 5 mm) (at an intrusion rate of 5 cm/min).

### Adhesion Test Method

1. A commercially available, quadrangular prism-shaped ice cream bar (trade name: Vanilla Bar, Lotte Co., Ltd.; shape of the ice cream portion: about 23 m×23 m×73 m) adjusted to −18° C. was placed in a glass beaker filled with a chocolate-like coating food product at 40° C. to the point of the wooden stick of the ice cream bar, to coat the bar with the chocolate-like food product.
2. The ice cream bar was pulled out of the chocolate-like food product, and held above the glass beaker such that the longitudinal side of the ice cream bar was perpendicular to the ground, allowing the extra chocolate-like food product to drop down. With the time point at which the ice cream bar was pulled out of the chocolate-like food product as the starting point, “the time period during which the extra chocolate-like food product dropped down until droplets stopped falling (i.e., dripping time)” was measured. The chocolate-like food product was then evaluated as to whether its physical properties were suitable for practical use. The amount of the chocolate-like food product adhered to the ice cream bar, and the viscosity of the chocolate-like food product at 40° C. (measured with a BM-type viscometer with a No. 2 rotor at 30 rpm) were also examined.
3. A dripping time of less than 10 seconds was rated “pass.”

TABLE 2
Results

| | Compa- | Compa- | Compa- | Compa- | Compa- | Compa- | Compa- | Compa- | Compa- | Compa- |
|---|---|---|---|---|---|---|---|---|---|---|
| | rative | rative | rative | rative | rative | rative | rative | rative | rative | rative |
| | Exam- | Exam- | Exam- | Exam- | Exam- | Exam- | Exam- | Exam- | Exam- | Exam- |
| | ple 1 | ple 2 | ple 3 | ple 4 | ple 5 | ple 6 | ple 7 | ple 8 | ple 9 | ple 10 |
| Hardness (g) | 500 | 520 | 600 | 500 | 500 | 500 | 500 | 500 | 500 | 500 |
| Dripping Time (S) | 29 | 17 | 19 | 20 | 21 | 28 | 13 | 11 | 20 | 20 |
| Coating Weight (g) | 5.3 | 9.1 | 8.7 | 6.6 | 6.5 | 7.2 | 8.1 | 10.6 | 6.7 | 6.8 |
| Viscosity (cp) | 475 | 470 | 595 | 600 | 680 | 605 | 550 | 630 | 515 | 550 |
| | Compa- | Compa- | Compa- | Compa- | Compa- | Compa- | Compa- | Compa- | Compa- | Compa- |
| | rative | rative | rative | rative | rative | rative | rative | rative | rative | rative |
| | Exam- | Exam- | Exam- | Exam- | Exam- | Exam- | Exam- | Exam- | Exam- | Exam- |
| | ple 11 | ple 12 | ple 13 | ple 14 | ple 15 | ple 16 | ple 17 | ple 18 | ple 19 | ple 20 |
| Hardness (g) | 500 | 500 | 500 | 500 | 520 | 550 | 520 | 550 | 350 | 380 |
| Dripping Time (S) | 18.0 | 17.0 | 14.0 | 13.0 | 19.0 | 20.0 | 19.0 | 21.0 | 30.0 | 18.0 |
| Coating Weight (g) | 7.0 | 8.0 | 8.8 | 9.2 | 8.5 | 9.0 | 8.8 | 8.9 | 5.1 | 8.5 |
| Viscosity (cp) | 595.0 | 490.0 | 505.0 | 520.0 | 480.0 | 540.0 | 475.0 | 505.0 | 450.0 | 455.0 |
| | Compa- | Compa- | Compa- | Compa- | | | | | | |
| | rative | rative | rative | rative | | | | | | |
| | Exam- | Exam- | Exam- | Exam- | Exam- | Exam- | Exam- | Exam- | Exam- | Exam- |
| | ple 21 | ple 22 | ple 23 | ple 24 | ple 1 | ple 2 | ple 3 | ple 4 | ple 5 | ple 6 |
| Hardness (g) | 440 | 350 | 350 | 350 | 500 | 520 | 600 | 520 | 600 | 520 |
| Dripping Time (S) | 20.0 | 22.0 | 20.0 | 28.0 | 8.0 | 4.0 | 4.0 | 7.0 | 6.0 | 6.0 |
| Coating Weight (g) | 7.7 | 6.0 | 6.2 | 5.8 | 9.5 | 11.7 | 13.5 | 11.3 | 12.6 | 11.2 |
| Viscosity (cp) | 565.0 | 570.0 | 630.0 | 610.0 | 505.0 | 615.0 | 670.0 | 750.0 | 900.0 | 655.0 |
| | Exam- | Exam- | Exam- | Exam- | Exam- | Exam- | Exam- | Exam- | Exam- | Exam- |
| | ple 7 | ple 8 | ple 9 | ple 10 | ple 11 | ple 12 | ple 13 | ple 14 | ple 15 | ple 16 |
| Hardness (g) | 600 | 520 | 600 | 520 | 600 | 520 | 600 | 520 | 600 | 520 |
| Dripping Time (S) | 5.0 | 8.0 | 7.0 | 5.0 | 5.0 | 5.0 | 6.0 | 6.0 | 5.0 | 4.0 |
| Coating Weight (g) | 12.2 | 10.7 | 11.9 | 11.4 | 12.8 | 12.5 | 14.0 | 10.3 | 11.1 | 11.0 |
| Viscosity (cp) | 700.0 | 490.0 | 450.0 | 525.0 | 560.0 | 690.0 | 705.0 | 520.0 | 575.0 | 570.0 |
| | Exam- | Exam- | Exam- | Exam- | Exam- | Exam- | Exam- | Exam- | Exam- | Exam- |
| | ple 17 | ple 18 | ple 19 | ple 20 | ple 21 | ple 22 | ple 23 | ple 24 | ple 25 | ple 26 |
| Hardness (g) | 600 | 520 | 600 | 520 | 600 | 520 | 600 | 520 | 600 | 520 |
| Dripping Time (S) | 4.0 | 7.0 | 6.0 | 9.0 | 8.0 | 8.0 | 7.0 | 8.0 | 7.0 | 5.0 |
| Coating Weight (g) | 12.2 | 11.1 | 11.8 | 10.8 | 11.7 | 11.2 | 11.5 | 11.5 | 11.9 | 11.5 |
| Viscosity (cp) | 645.0 | 650.0 | 810.0 | 505.0 | 550.0 | 530.0 | 570.0 | 545.0 | 590.0 | 610.0 |
| | Exam- | Exam- | Exam- | Exam- | Exam- | Exam- | Exam- | Exam- | Exam- | Exam- |
| | ple 27 | ple 28 | ple 29 | ple 30 | ple 31 | ple 32 | ple 33 | ple 34 | ple 35 | ple 36 |
| Hardness (g) | 600 | 520 | 600 | 520 | 600 | 520 | 600 | 520 | 600 | 520 |
| Dripping Time (S) | 4.0 | 6.0 | 5.0 | 7.0 | 5.0 | 6.0 | 5.0 | 6.0 | 5.0 | 7.0 |
| Coating Weight (g) | 12.8 | 12.0 | 12.9 | 11.8 | 12.5 | 11.3 | 12.0 | 11.5 | 12.0 | 11.3 |
| Viscosity (cp) | 650.0 | 700.0 | 720.0 | 660.0 | 690.0 | 600.0 | 620.0 | 680.0 | 705.0 | 620.0 |

| | | | | | | | Exam- |
|---|---|---|---|---|---|---|---|
| | Example 37 | Example 38 | Example 39 | Example 40 | Example 41 | Example 42 | ple 43 |
| Hardness (g) | 600 | 380 | 440 | 380 | 440 | 380 | 440 |
| Dripping Time (S) | 6.0 | 4.0 | 4.0 | 6.0 | 5.0 | 6.0 | 6.0 |
| Coating Weight (g) | 12.0 | 12.1 | 13.2 | 11.1 | 11.8 | 10.9 | 11.2 |
| Viscosity (cp) | 645.0 | 590.0 | 660.0 | 700.0 | 780.0 | 665.0 | 720.0 |

### DISCUSSION

The results reveal that due to the specific fat and oil and emulsifier contained, the fat and oil coating compositions that have a specific value of physical properties exhibited shortened dripping time, and contribute to streamlining the production of frozen confections.

1. A fat and oil composition for coating frozen confections,
the composition comprising
0.1 to 3 wt % of fat and oil having a melting point of 50° C. or more, and
0.05 to 3 wt % of an emulsifier having an HLB of 9 or less,
the composition having a hardness of 200 to 1500 g as measured with a rheometer using a plunger having φ 5 mm at −18° C. at an intrusion rate of 5 cm/min.

2. The fat and oil composition for coating frozen confections according to claim 1, wherein the emulsifier having an HLB of 9 or less is at least one member selected from the group consisting of sugar esters and sorbitan fatty acid esters.

3. The fat and oil composition for coating frozen confections according to claim 1, wherein the fat and oil having a melting point of 50° C. or more is a fully hydrogenated high-erucic-acid rapeseed oil.

4. The fat and oil composition for coating frozen confections according to claim 2, wherein the fat and oil having a melting point of 50° C. or more is a fully hydrogenated high-erucic-acid rapeseed oil.

5. A method for producing a frozen confection coated with a fat and oil composition, the method using the fat and oil composition for coating frozen confections according to claim 1.

6. A method for producing a frozen confection coated with a fat and oil composition, the method using the fat and oil composition for coating frozen confections according to claim 2.

7. A method for producing a frozen confection coated with a fat and oil composition, the method using the fat and oil composition for coating frozen confections according to claim 3.

8. A method for producing a frozen confection coated with a fat and oil composition, the method using the fat and oil composition for coating frozen confections according to claim 4.

9. A method for shortening the time period during which a fat and oil composition drops in the production of a frozen confection,
the method comprising forming the fat and oil composition so as to contain 0.1 to 3 wt % of fat and oil having a melting point of 50° C. or more and 0.05 to 3 wt % of an emulsifier having an HLB of 9 or less in the production of a frozen confection coated with the fat and oil composition,
wherein the fat and oil composition has a hardness of 200 to 1500 g as measured with a rheometer using a plunger having φ 5 mm at −18° C. at an intrusion rate of 5 cm/min.

10. The method for shortening the time period during which a fat and oil composition drops in the production of a frozen confection according to claim 9, wherein the emulsifier having an HLB of 9 or less is at least one member selected from the group consisting of sugar esters and sorbitan fatty acid esters.

11. The method for shortening the time period during which a fat and oil composition drops in the production of a frozen confection according to claim 9, wherein the fat and oil having a melting point of 50° C. or more is a fully hydrogenated high-erucic-acid rapeseed oil.

12. The method for shortening the time period during which a fat and oil composition drops in the production of a frozen confection according to claim 10, wherein the fat and oil having a melting point of 50° C. or more is a fully hydrogenated high-erucic-acid rapeseed oil.
